(19) United States
(12) Patent Application Publication
(10) Pub. No.: US 2005/0173993 A1
(43) Pub. Date: Aug. 11, 2005

(54) Method for producing a three-phase alternating-current winding for a linear motor

(76) Inventors: Peter Zamzow, Bochum (DE); Dirk Steinbrink, Burgwedel (DE); Georg Talian, Moers (DE)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(21) Appl. No.: 10/999,897

(22) Filed: Nov. 30, 2004

(30) Foreign Application Priority Data
Dec. 12, 2003 (EP) 03293149.5

(51) Int. Cl. H02K 41/00

(52) U.S. Cl. 310/12

(57) ABSTRACT

In a method for producing a three-phase alternating current winding for a linear motor, which has a rotor part (7) and an elongated stator (4), which consists of an inductor provided with grooves (5) and three phase windings (1), which lie in the grooves (5), which are provided with recesses for closure devices, and in which the phase windings (1) consist of electric cables that can be connected with one another to form a cohesive winding, each of the three phase windings (1) is first shaped as a meander, the meander windings are fixed in place by at least one band-shaped element (2, 3), and the phase windings (1) are pressed into the grooves (5) of the stator (4) either individually in succession or together.

The invention concerns a method for producing a three-phase alternating current winding for a linear motor in accordance with the introductory clause of Claim 1.

Linear motors have long been known for a wide variety of electric drives. There are both direct-current and alternating-current synchronous and asynchronous motors. In contrast to a conventional motor, in a linear motor, the stator and rotor are arranged linearly rather than circularly. The electrical energy is transformed to mechanical energy in such a way that it can be used directly for translational motion.

The linear motor can basically have an excitation winding that is arranged in grooves of the stator and designed for three-phase alternating current. The rotor part then consists of a bar made either of a material that is a good electrical conductor, such as copper or aluminum (asynchronous motor), or of a permanent-magnet material (synchronous motor). However, linear motors in which the winding is arranged in the rotor part are also known.

Areas of application for linear motors include, for example, conveyance of people, conveyance and transportation, assembly lines, etc. Depending on the area of application, the motors are more or less long. The winding can be arranged in the usual way in the grooves of the stator. The longer the stator is, the more work is involved in the installation of the individual winding strands. It has always been necessary for this work to be performed by experts When a linear motor with an elongated stator that carries the excitation winding is used as the drive for a conveyance or transport device, the stator with the winding must be mounted along the entire traveling path of the vehicle that is to be driven. For this purpose, first the active part of the stator (the inductor) in the form of many sheet laminations is mounted on the carrier on which the vehicle is to be moved. The winding, which consists of the three electric cables, is then mounted in the grooves of the sheet laminations, which are open towards the bottom. If some auxiliary devices cannot be installed, the winding must be pressed into the grooves from below and secured in them, which involves considerable installation work, especially since this work always has to be performed above one's head.

In a method described in DE 28 27 150 A, the entire winding, which has been prefabricated at the factory, is first laid on a number of supports, which are arranged below the inductor. The winding is then gradually inserted in the grooves. Despite the use of a prefabricated, single-piece winding, this method is still labor-intensive, especially since it still requires manual labor to press the winding into the grooves.

DE 33 23 696 A describes a method for inserting a prefabricated alternating-current winding in the grooves of an elongated inductor. In this method, which is intended for Transrapid, the coil with the winding is arranged on a vehicle that can be moved on the carrier, and the winding is pulled from the coil as the vehicle moves along the carrier. The winding is continuously pressed into the grooves of the inductor by means of a deflection system.

A disadvantage of this method is that the length of cable that can be laid is limited by the capacity of the cable coil and by the ability to handle it.

It is known from the applicant's brochure “Transrapid—Future Becomes Reality” that the formation of the meanders and of the necessary crimps can be carried out by a cable-laying vehicle that can be moved on the travel path. To this end, first a coil with a first cable is positioned on the cable-laying vehicle, the cable is drawn off from the coil, and the meanders and crimps are produced in the same operation.

To fix the geometry of the shaped cable, iron bands with grooves are pressed onto the shaped cable. Finally, the cable together with the iron bands is pressed into the groove of the inductor. The same procedure is followed with the two succeeding cables.

A disadvantage here is that additional preformed metal bands must be used.

The objective of the present invention is to specify a method in which the winding can be largely produced in the factory, and the geometry of the winding is preserved during shipment and during insertion in the grooves.

This objective is achieved by the features specified in the characterizing clause of Claim 1.

Other advantageous refinements of the invention are specified in the dependent claims and are described below with reference to the drawings.

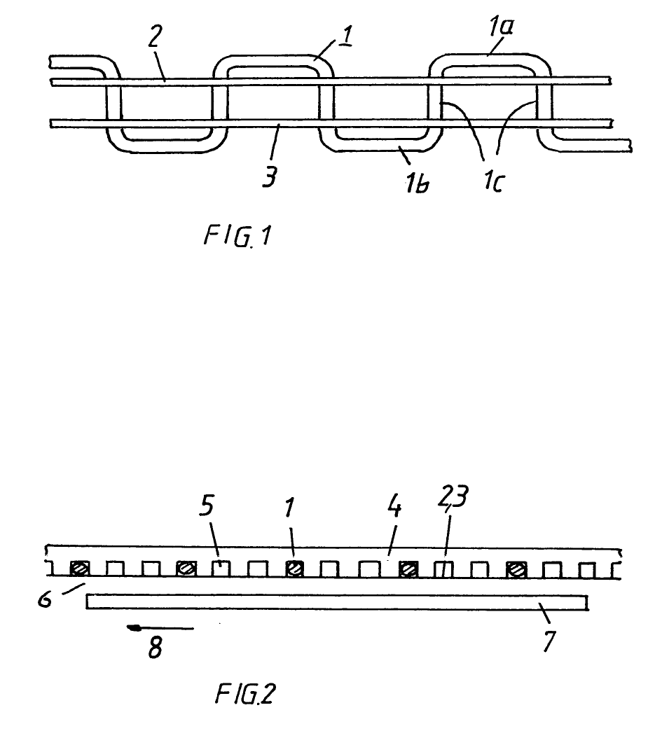

The invention is explained in greater detail below with reference to the embodiments schematically illustrated in FIGS. 1 and 2.

FIG. 1 shows a top view of a phase winding, which consists of a cable 1, which is shaped as a meander. In addition, the regions 1a and 1b are crimped, i.e., they are deformed upward or downward out of the plane of the phase winding.

The geometry of the phase winding is maintained by two retaining straps 2 and 3, which are adhesively bonded with the regions 1c of the cable 1. The retaining straps 2 and 3 consist of a material of high tensile strength, preferably a glass fabric strap with a layer of adhesive on one side. The shaping of the meander and the crimping are carried out in the manufacturing plant on a machine specially designed for this. The phase winding produced in this way is wound on a cable drum and shipped to the site of use. When the phase winding is being wound onto the cable drum, the retaining straps 2 and 3 must face inward towards the core of the drum.

FIG. 2 shows a schematic side view of a linear motor.

A stator 4, which consists of a ferromagnetic material, has grooves 5, in which a phase winding 1 is installed to produce an electromagnetic traveling field. The rotor 7, which is separated from the stator 4 by an air gap 6, is mounted on an object to be moved, e.g., the Transrapid, which, during operation of the linear motor, can be moved, for example, in the direction of the arrow 8. The rotor 7 is made, for example, of copper or aluminum or of a permanent-magnet material and is mounted on the vehicle, which is moved along a given track.

FIG. 2 shows the state after the insertion of the first phase winding 1 in the grooves 5 of the stator 4. After the first phase winding 1 has been pressed into the grooves 5 of the stator 4, the retaining straps 2 and 3 are pulled off to provide free access to the grooves 5 for the second phase winding, which are located between the grooves 5 already occupied by the first phase winding 1.

The second phase winding is then drawn off from a second cable drum and pressed into the grooves 5 next to the grooves 5 that are already occupied. The retaining straps 2 and 3 are also pulled off of this phase winding. Finally, the third phase winding is inserted in the open grooves 5 in the same way. In the case of the third phase winding, the retaining straps 2 and 3 can be pulled off or kept on.

In accordance with an especially advantageous refinement of the invention, the retaining straps 2 and 3 are attached to the phase windings 1 in such a way that they are located outside of the grooves 5 of the stator. It then becomes unnecessary to pull off or cut the retaining straps 2 and 3.

The phase windings can be prefabricated in the desired length, i.e., adjusted to the length of the travel path. Plug connectors can be provided on the ends of the phase windings at the factory for connecting adjoining phase windings, so that assembly no longer requires expensive couplings.

In accordance with another idea of the invention, the three phase windings 1 can be combined into one winding and shipped, for example, on a cable drum, to the site of use, where the winding as a whole can then be pressed into the grooves of the stator.

1. Method for producing a three-phase alternating current winding for a linear motor, said motor having a rotor part and an elongated stator, which consists of an inductor provided with grooves and three phase windings, which lie in the grooves and which are provided with recesses for closure devices, wherein the phase windings consist of electric cables that can be connected with one another to form a cohesive winding, said method comprising the steps of:
shaping each of the three phase windings as a meander, where the meander windings are fixed in place by at least one band-shaped element; and
pressing the phase windings into the grooves of the stator either one of individually in succession, or together.

2. Method in accordance with claim 1, wherein the individual phase windings are combined into one winding and the winding is pressed into the grooves of the stator.

3. Method in accordance with claim 1, wherein two straps spaced a certain distance apart are used to fix the meander windings in place.

4. Method in accordance with claim 1, wherein the straps are arranged on the surface that faces the inductor.

5. Method in accordance with claim 1, wherein the straps are applied on the regions of the phase windings that project from the grooves.

6. Method in accordance with claim 1, wherein the strap or straps are adhesively bonded to the meander windings.

7. Method in accordance with claim 1, wherein straps made of reinforced glass fabric are used.

8. Method in accordance with claim 1, wherein each phase winding is wound on a cable drum or cable coil after the meander windings have been fixed in place, shipped to the site of use, and then pressed into the grooves.

9. Method in accordance with claim 1, wherein the straps are removed after each of the phase windings has been inserted.

10. Method in accordance with claim 1 for a stator mounted on a carrier of a certain length, wherein the individual phase windings are prefabricated to the length of the carrier.

11. Method in accordance with claim 10, wherein the ends of each phase winding are provided with plug connectors.
